(19) United States
(12) Patent Application Publication
(10) Pub. No.: US 2025/0171647 A1
(43) Pub. Date: May 29, 2025

(54) BIOINSPIRED THERMAL ACTIVATED SYSTEMS AND SELF-SOFTENING MATERIALS

(71) Applicant: THE REGENTS OF THE UNIVERSITY OF CALIFORNIA, Oakland, CA (US)

(72) Inventors: David Kisailus, Irvine, CA (US); Devis Montroni, Irvine, CA (US)

(21) Appl. No.: 18/841,857

(22) PCT Filed: Mar. 6, 2023
(86) PCT No.: PCT/US2023/014635

§ 371 Date: Aug. 27, 2024

Related U.S. Application Data
(60) Provisional application No. 63/316,872, filed on Mar. 4, 2022.

(51) Int. Cl. C09D 5/18

(52) U.S. Cl. CPC C09D 5/185

(57) ABSTRACT

Materials comprising a protective coating for thermal protection are disclosed herein. The protective coating is comprised of a sacrificial layer, sacrificial component, or an intumescent layer organized in diverse geometries bioinspired from the thermal resistant structures in pyrophytic plants from the Banksia genus. The protective coating can be applied to various substrates and used for thermal management, water rescue, or crash safety.

### CROSS-REFERENCE TO RELATED APPLICATIONS

This application claims benefit of U.S. Provisional Application No. 63/316,872 filed Mar. 4, 2022, the specification(s) of which is/are incorporated herein in their entirety by reference.

### FIELD OF THE INVENTION

The present invention relates to bioinspired insulating layers for external thermal management and to materials that can self-soften after being triggered with heat. In one embodiment, the bioinspired insulating layers and materials may be used for fire or thermal protection, and/or protection from physical or structural damage, and/or for safety and personal protective equipment.

### BACKGROUND OF THE INVENTION

Banksia speciosa is a plant that relies on wildfires to propagate its seeds. Once the flower is pollinated the plant develops a structure known as a follicle that encases the seeds of the plant. This structure shows specific compositional and structural features that allow the seeds to be protected from temperatures over a thousand degrees Celsius. Analogue systems from other species in the Banksia genus that do not rely on wildfires for propagation completely decompose if exposed to analogue thermal conditions (fully compromising the seeds). This system represents an intriguing source of knowledge for bioinspired systems of thermal management.

The present invention features thermal management bioinspired from the external layers that encase the follicle, which rely on a combination of compositional and structural features, especially intumescence to create an external insulating layer.

### BRIEF SUMMARY OF THE INVENTION

It is an objective of the present invention to provide bioinspired insulating systems that allow for protection of external systems, as specified in the independent claims. Embodiments of the invention are given in the dependent claims. Embodiments of the present invention can be freely combined with each other if they are not mutually exclusive.

In some embodiments, the present invention may be used for thermal or fire protection. In some embodiments, the present invention features self-inflating or self-softening materials triggered by heat. The invention disclosed herein maintains unique inventive technical features relating to the architecture and possible geometries of each component capable of deflecting, absorbing, and scattering thermal energy. Without wishing to limit the invention to any theory or mechanism, it is believed that the technical feature of the present invention advantageously provides for protection of external surfaces applicable for thermal management, water rescue, or crash safety. For example, the present invention may provide self-inflating materials for water rescues, and self-softening/inflating materials, similar to airbags, for crash safety. None of the presently known prior references or work has the unique inventive technical feature of the present invention.

In some embodiments, the present invention features a protective coating comprising at least one intumescent layer and/or at least one sacrificial component. In some embodiments, the protective coating comprises a plurality of sacrificial components embedded in a plurality of intumescent layers.

According to other embodiments, the present invention also features a protective coating comprising at least one sacrificial layer and/or at least one intumescent layer. In some aspects, the protective coating comprises a plurality of alternating intumescent and sacrificial layers.

According to other embodiments, the present invention also features a protective coating comprising an intumescent layer.

According to some other embodiments, the present invention also features a protective coating comprising a sacrificial layer, and a sacrificial component embedded within an intumescent layer. In yet other embodiments, the present invention also features a protective coating comprising at least one sacrificial component and at least one sacrificial layer.

In some embodiments, the present invention also features a sacrificial layer composed of thermally insulating materials that can undergo phase transformations (e.g., meta-stable metal oxide, carbonate, oxalate materials, as well as thermally insulating polymers such as polyimides, etc.).

In some embodiments, the intumescent layer is an elastic structure and expands to create empty, or gas filled pockets when heated. In some aspects, the intumescent layer is comprised of either organic (e.g., high glass transition temperature thermoplastic biological or synthetic) polymers or inorganic (e.g., flexible ceramics or poly-inorganic) materials. In some embodiments, the intumescent layer is comprised of material with a random distribution or periodic (e.g., cubic, hexagonal, tetragonal, etc.) distribution or lamellar, helicoidal, or tubular structural organization. In some embodiments, the intumescent layer is thermally resistant.

According to other embodiments, the present invention also features a protective coating comprising a sacrificial component. In some aspects, the sacrificial component is comprised of decomposable polymeric (either synthetic or biological) or inorganic (e.g., calcium oxalate) materials. In some embodiments, the sacrificial component degrades upon heating with a neutral or negative thermic contribution.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a schematic of a thermal protective coating of the present invention, where a sacrificial component forms an ash layer that prevents adsorption or permeability of O₂ and thermal energy while consuming oxygen.

FIG. 1B shows a schematic of a thermal protective coating according to another embodiment of the present invention, where the sacrificial component is embedded in an intumescent layer and can form bubbles by releasing gas as a result of absorbing thermal energy.

FIG. 1C shows a schematic of a thermal protective coating according to yet another embodiment of the present invention, where the intumescent layer can absorb thermal energy, expand, and/or form bubbles.

FIGS. 2A to 2H shows various embodiments of the thermal protective coating of the present invention. Referring to the legend, the thermal protective coating is disposed on an underneath material and can comprise a combination of component 1, component 2, component 1 or 2, and component 3, also referred to as a general matrix. FIG. 2A shows a single layer of component 1 or 2 on the matrix. FIG. 2B shows alternating layers of component 1 or 2 and the matrix. FIG. 2C shows particles of component 2 embedded in the matrix having a protective sacrificial layer of component 1 disposed thereon. FIG. 2D shows patterned islands of component 2 embedded in the matrix with a protective sacrificial layer of component 1 disposed thereon. FIG. 2E shows a single degrading layer of component 1 or 2 beneath the matrix. FIG. 2F shows a sacrificial layer of component 1 embedded as fibers in the matrix. FIG. 2G shows a particle-based morphology of component 2 layered with particles of component 1 or 2. FIG. 2H shows an example of a morphology comprising a layer of component 1 or 2 on a layer of component 2 without the matrix.

FIG. 3 shows a schematic of a Banksia follicle before and after being exposed to a wildfire. The names of the single components are shown around the follicle.

FIG. 4 shows a schematic of the intumescence process and thermal degradation of the external follicle coating.

FIGS. 5A to 5B shows optical images of the external layers of a follicle.

FIG. 5C shows an SEM image of the external layer of a follicle (most of the external hairs have been removed during sample preparation). The left arrow indicates the external hairs, the middle arrow indicates the external resin layer, and the right arrow indicates the lignin tablets.

FIG. 6A shows TGA (above) and DSC (below) profiles of the external hairs in air. Dashed lines indicate the region where most of the external hairs degrade. The analyses were performed using a 10° C. per min heating ramp.

FIG. 6B shows TGA (above) and DSC (below) profiles of the external resin in air. Dashed lines indicate the region where most of the external hairs degrade. The analyses were performed using a 10° C. per min heating ramp.

FIG. 6C shows TGA (above) and DCS (below) profiles of Ar atmospheres. Dashed lines indicate the region where most of the external hairs degrade. The analyses were performed using a 10° C. per min heating ramp.

### DETAILED DESCRIPTION OF THE INVENTION

According to some embodiments, the present invention comprises materials of diverse geometries that implement sacrificial components. These components could have mostly two roles: (i) create a protective layer that consume or prevent the diffusion of oxygen, preventing the degradation of the layer responsible for the intumescence; and (ii) upon heating degrade and create gas that inflate the foam responsible for the intumescence or forms a layer of inert gas over the protected surface.

As used herein, the “intumescent layer” is defined as a substrate capable of swelling when heated by forming a foam with gas pockets inside.

As used herein, the term “sacrificial” is defined as the ability of a substrate to degrade into a stable layer of ash, while also consuming oxygen or thermal energy along this process.

As used herein, the “sacrificial layer” is defined as a sacrificial substrate composed of polymeric or inorganic materials capable of insulating and preventing gas diffusion.

As used herein, the “sacrificial component” is defined as a sacrificial substrate composed of either polymeric (both synthetic or biological polymers) or inorganic material in a particle-based arrangement capable of thermal management by absorbing heat and transforming to a gas that produces insulating pores within an intumescent layer or a flux of inert gas when used by itself.

As used herein, the term “metastable” as known to one of ordinary skill in the art refers to an intermediate state in which a system can remain somewhat stable for a long period of time.

As used herein, a high glass transition temperature above 120° C. In some embodiments, thermoplastics with high glass transition temperatures include, but are not limited to, polycarbonate, polyetheretherketone (PEEK), polyimide, polysulfone, and polyetherimide.

Nanoscaling imparts flexibility to ceramics. As used herein, flexible ceramics include, but are not limited to, doped or undoped ZrO2, TiO2, ZnO, SiC, etc.

As used herein, poly-inorganic materials include, but are not limited to, polysilazanes, polycarbosilanes, poly metal phosphates, etc.

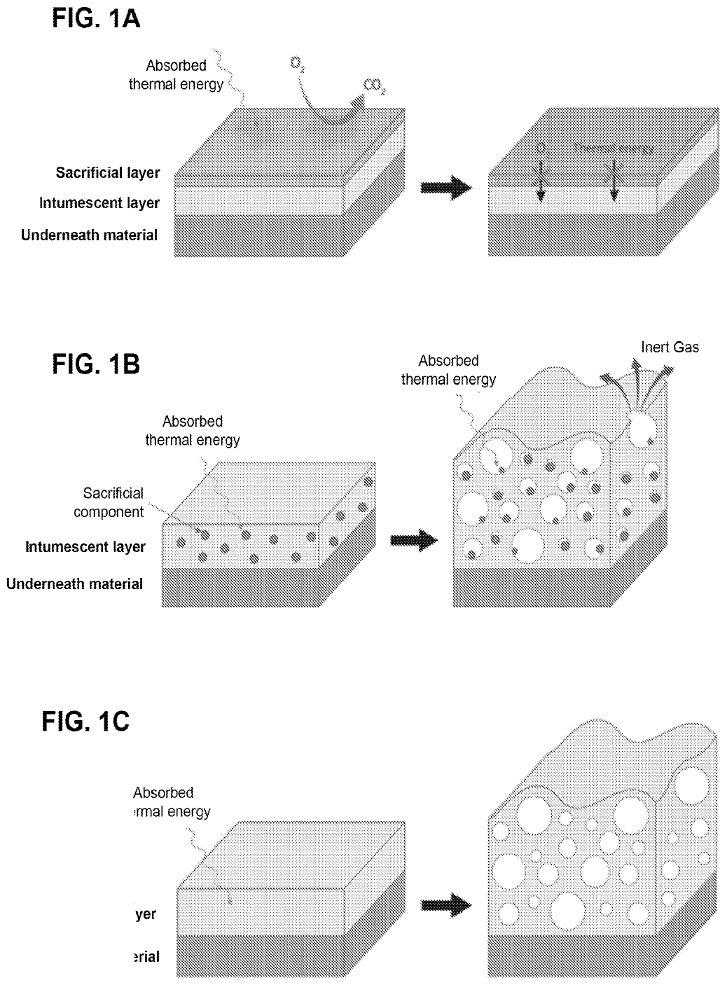

According to some embodiments, a general schematic of the functioning process of each of the three components are shown in FIG. 1. The distribution of these components could be as layer or alternate layers, as pocket with a different composition inside the matrix material (which may be responsible for the intumescence) or dispersed in the matrix as random particles. The first component could be deposited as a compact or porous layer or fibers (as in the biological analogue) to allow a higher exposed surface. The degradation of the material should be thermally neutral (no heat generated from the degradation) or negative (absorb heat during the degradation process). The process may or may not consume oxygen or other reactive components (i.e., radicals, carbon monoxide) during the reaction.

After this first event, a stable layer of ashes should be present. The layer may have different advantages: (i) create an insulating layer (e.g., blocking irradiation, convection, or conduction of heat); (ii) prevent general or specific gas diffusion to the intumescent layer. The material composing this layer could be based on organic (i.e., polymers or crosslinked materials), inorganic (i.e., minerals or coordination compounds, either polymeric, crosslinked, or supramolecular structures) or mixture of these two components. This protective component could be also used alone as a protective layer or coupled with a layer giving rise to intumescence or other thermal management contribution (i.e., insulation, heat dispersion or adsorption).

The second component discussed may or may not be used in combination with the other one or with an intumescent material or another material responsible for thermal management or protection, meaning this component could also be used by itself or encapsulated in a general matrix. It could be deposited as a layer or multiple layers with other components or as particles or pockets organized (i.e. pattered) or not inside a matrix. As a layer it could be a compact or porous material, or a particle-based layer. The component, as the lignin in the native system, should degrade upon heating with a neutral or negative thermic contribution. Its degradation could be a multistep process (i.e., calcium oxalate that converts into calcium carbonate and then in calcium oxide) or a single step process (i.e., calcium carbonate to calcium oxide) and its degradation should produce a gas not actively involved in fire chemistry (i.e., CO₂, N₂). The material can have different contributes: (i) absorbing thermal energy without generating any energy; (ii) generate a light flux of inert gas that insulate the direct proximity of the material and/or displace warm gas in direct contact with the material; (iii) produce a gas that could inflate the material responsible to the intumescence process.

The last component comprises the material responsible for the intumescence itself. This material may have gas bubbles inside that expand upon heating, a component that degrades producing gas upon heating, degrades itself generating gas that inflates the material itself, or being deposited with a geometry (or an internal stress) that upon heating expansion creates empty (or gas filled) pockets. The material could be organic, inorganic or a mixture of them, with a polymeric, supramolecular, fibrous or crosslinked organization. The material should have an elastic structure (i.e., due to chemical bond flexibility, ring opening, or unfolding of organized or random coiled regions) and should be thermally resistant in the temperature range defined (which would depend on the type of fire targeted). This elasticity would be crucial upon its expansion. In case the expansion is dictated by internal stresses or geometries, the flexibility might not be required (instead, a stiffer material might be better).

These three components may be fully combined, partially combined, being used singularly, or being combined with other components, technologies or materials. They could constitute thin protective coatings (from 0.01 to 1 mm) (i.e., used on walls, panels, or clothes) or bulk materials (from 1 mm to 10 m) (i.e., creating panel or tissues), or being used to impregnate a tissue or another matrix to implement new properties. The materials may be used for protective purposes, to manipulate the mechanical properties of the material (i.e., to create a soft protective layer), or to obtain inflatable materials or devices.

According to some embodiments, the present invention features a protective coating comprising at least one intumescent layer and at least one sacrificial component. The sacrificial component is disposed on, layered under, or partially embedded or fully embedded in the intumescent layer. In some embodiments, the protective coating comprises a plurality of sacrificial components and a plurality of intumescent layers. In some aspects, the sacrificial component degrades upon heating with a neutral or negative thermic contribution (e.g., endothermic contribution). In further embodiments, a sacrificial layer may be disposed on the intumescent layer.

In some embodiments, the intumescent layer is an elastic structure and expands to create empty, or gas filled pockets when heated as shown in FIG. 1B to FIG. 1C. In some aspects, the intumescent layer is comprised of either organic (e.g., high glass transition temperature thermoplastic biological or synthetic) polymers or inorganic (e.g., flexible ceramics or poly-inorganic materials with either a random distribution or periodic (e.g., cubic, hexagonal, tetragonal, etc.) distribution or lamellar, helicoidal, tubular architecture (structural organization). In some embodiments, the intumescent layer is thermally resistant.

In some embodiments, the sacrificial component is comprised of particles, films, or stacks of tablets. In some embodiments, the sacrificial component is comprised of decomposable polymeric (either synthetic or biological) or inorganic (e.g., calcium oxalate) materials. Non-limiting examples of the sacrificial component include cellulose, lignin, synthetic analogs of lignin, fibers, low molecular weight polymers, high molecular weight polymers, branched polymers, pendant polymers, metastable ceramics, metastable metal oxides, carbonates, oxalates, polyimides, biopolymer derivatives, or combinations thereof. It is understood that these aforementioned materials are intended to be examples only, and are non-limiting and non-exhaustive. Other compounds and materials are within the scope of the present invention.

In some embodiments, the sacrificial component is composed of thermally insulating materials that can undergo phase transformations (e.g., meta-stable metal oxide, carbonate, oxalate materials, as well as thermally insulating polymers such as polyimides, etc.).

In some aspects, the sacrificial component degrades upon heating with a neutral or negative thermic contribution (e.g., endothermic contribution). In some embodiments, the sacrificial component is adapted to thermally degrade and consume O₂ to form an ash layer that lowers a permeability of O₂ or prevents O₂ from passing through and acts as an insulating layer. In some embodiments, the sacrificial component can be configured to decompose at a specific temperature.

In other embodiments, the sacrificial component is adapted to form a non-combustible gas when heated or burned. Examples of the non-combustible gas include, but are not limited to, nitrogen, argon, helium, neon, krypton, or CO₂. For example, thermal degradation of azides or amines can form a non-combustible gas comprising nitrogen. In some embodiments, the sacrificial component is adapted to form a gas that fills spaces in the intumescent layer as the intumescent layer expands.

According to other embodiments, the present invention features a protective coating comprising at least one sacrificial layer and at least one intumescent layer. The sacrificial layer may be disposed on the intumescent layer or vice versa. In another embodiment, the protective coating may comprise a plurality of alternating intumescent and sacrificial layers. The protective coating may further comprise a sacrificial component embedded within or disposed on the intumescent layer or the sacrificial layer.

In some embodiments, the sacrificial layer may be comprised of insulating materials that can undergo phase transformations. The sacrificial layer may be comprised of decomposable polymeric or inorganic materials. Non-limiting examples of the sacrificial layer includes cellulose, lignin, synthetic analogs of lignin, low molecular weight polymers, high molecular weight polymers, branched polymers, metastable ceramics, metastable metal oxides, carbonates, oxalates, polyimides, biopolymer derivatives, or combinations thereof. It is understood that these aforementioned materials are intended to be examples only, and are non-limiting and non-exhaustive. Other compounds and materials are within the scope of the present invention.

In some embodiments, the sacrificial layer can decompose at a specific temperature. In some embodiments, the sacrificial layer degrades upon heating with a neutral or endothermic contribution. In preferred embodiments, the sacrificial layer is adapted to thermally degrade and consume O₂ to form an ash layer that lowers permeability of O₂ or prevents O₂ from passing through and acts as an insulating layer. The sacrificial layer can be adapted to form a non-combustible gas when heated or burned. For example, the non-combustible gas may comprise nitrogen, argon, helium, neon, krypton, or CO₂.

In alternative embodiments, the protective coating may comprise just the intumescent layer.

In other alternative embodiments, the protective coating may comprise at least one sacrificial component, at least one sacrificial layer, or a combination thereof. The sacrificial component may be disposed on the sacrificial layer or vice versa. In some other embodiments, the protective coating comprises a plurality of sacrificial components and a plurality of sacrificial layers.

In accordance with any of the protective coatings described herein, the intumescent layer may be an elastic structure. In some embodiments, the intumescent layer may be comprised of a material with a random distribution or periodic distribution or lamellar, helicoidal, or tubular structural organization. The intumescent layer may be adapted to expand and create empty or gas filled pockets when heated. The intumescent layer may be non-degradable and/or thermally resistant.

In some embodiments, the intumescent layer is comprised of organic polymers or inorganic materials. For example, the intumescent layer may be comprised of biopolymers or synthetic polymers, thermoplastics with high glass transition temperatures, flexible ceramics, or poly-inorganic materials. In other embodiments, the intumescent layer may be a foam comprising polyurethane, isocyanate, polyols, or polylactic acid. It is understood that these aforementioned materials are intended to be examples only, and are non-limiting and non-exhaustive. Other compounds and materials of the intumescent layer are within the scope of the present invention.

In some embodiments, the protective coating can act as a thermal insulator. In one embodiment, the sacrificial component degrades to produce a flux of inert, relatively cold gas that impedes oxygen or heat from diffusing to an underlying surface.

In other embodiments, the protective coating is self-inflating or self-softening. In some embodiments, the coating can be activated by a thermal trigger to inflate or soften.

According to some embodiments, the present invention features a manufactured article comprising a protective coating according to any of the coatings described herein. In one embodiment, the protective coating is disposed on at least a portion of the article. For example, the protective coating may be applied on a surface of the article. In another embodiment, a manufactured article is constructed or formed from the protective coating.

In some embodiments, the article may be constructed from a material comprising steel, metal, wood, plastic, plaster, clay, composite, or concrete. In some embodiments, the manufactured article may be an aerospace structure or device, automotive material, personal protective structure, roofing material, a building material, furniture, or flooring material.

According to other embodiments, the present invention features a manufactured surface comprising a protective coating according to any of the coatings described herein. In some embodiments, the protective coating is disposed on at least a portion of the surface. In other embodiments, the manufactured surface is constructed or formed from the protective coating. In some embodiments, the surface may be constructed from a material comprising steel, metal, wood, plastic, plaster, clay, or concrete. In some embodiments, the manufactured surface may be a wall, a panel, a floor or ground surface, a beam, a ceiling, or roof.

The protective coatings of the present invention as described herein may be utilized in methods of preventing or reducing damage to an article or surface. Thus, it is another objective of the present invention to provide said methods.

According to some embodiments, the present invention features a method of preventing or reducing thermal or fire damage to an article. The method may comprise applying a protective coating to at least a portion of a surface of the article. In preferred embodiments, the coating is a thermal insulator. According to other embodiments, the present invention features a method of preventing or reducing structural damage to an article. The method may comprise applying a protective coating to at least a portion of a surface of the article. In preferred embodiments, the coating is self-inflating or self-softening. In some embodiments, the protective coating may be applied to an article by 3D printing, dip coating, spray coating, spin coating, painting, adhesive layering, or drop casting.

In other embodiments, the method of preventing or reducing thermal or fire damage to an article may comprise constructing or forming the article from a material comprising the protective coating. In preferred embodiments, the coating is a thermal insulator. In some other embodiments, the method of preventing or reducing structural damage to an article may comprise constructing or forming the article from a material comprising the protective coating. In preferred embodiments, the coating is self-inflating or self-softening. In some embodiments, the article is constructed or formed by 3-D printing, molding, casting, or extruding the material.

In some embodiments, the present invention features a method of preventing or reducing thermal or fire damage to a surface. The method may comprise applying a protective coating to at least a portion of a surface of the surface. In preferred embodiments, the coating is a thermal insulator. In other embodiments, the present invention features a method of preventing or reducing structural damage to a surface. The method may comprise applying a protective coating to at least a portion of the surface. In preferred embodiments, the coating is self-inflating or self-softening. In some embodiments, the protective coating may be applied onto the surface by 3D printing, dip coating, spray coating, spin coating, painting, adhesive layering, or drop casting.

Without wishing to limit the invention to a particular theory or mechanism, the protective coating can prevent thermal damage to the article or surface when the article or surface is exposed to temperatures of up to about 2000° C.

The Banksia genus contains plants which after pollination develop a wooden structure, called follicle, that encase the seeds. These plants are typical of Western Australia or other areas where wildfires are natural events occurring every year. The constant exposure of some of these plants to periodic wildfire generates an evolutionary pressure that led to species dependent on the wildfire itself. Some species of Banksia, such as Banksia speciosa, are in fact dependent on wildfire to properly open the follicle structure, exposing the seed to the outside world to propagate during the first rain as shown in FIG. 3. This approach has few advantages for the seeds, such as lower competitions for growing or a more fertile substrate to grow on. On the other hand, the plant was forced to develop a thermal resistant system that allows protection from wildfire and natural events each year.

The structural and compositional features of the Banksia genus (i.e., Banksia speciosa) plants were used to develop new materials or structures for thermal/fire management and/or protection, or thermal activated materials. In some embodiments, the present invention focuses on the external hairs and the external resin coating of the follicle, as well as the layer underneath the resin, composed of lignin tablets as shown in FIG. 3. This work may however be extended to any of the other components in this system (i.e., follicle valves, seed separator, etc.).

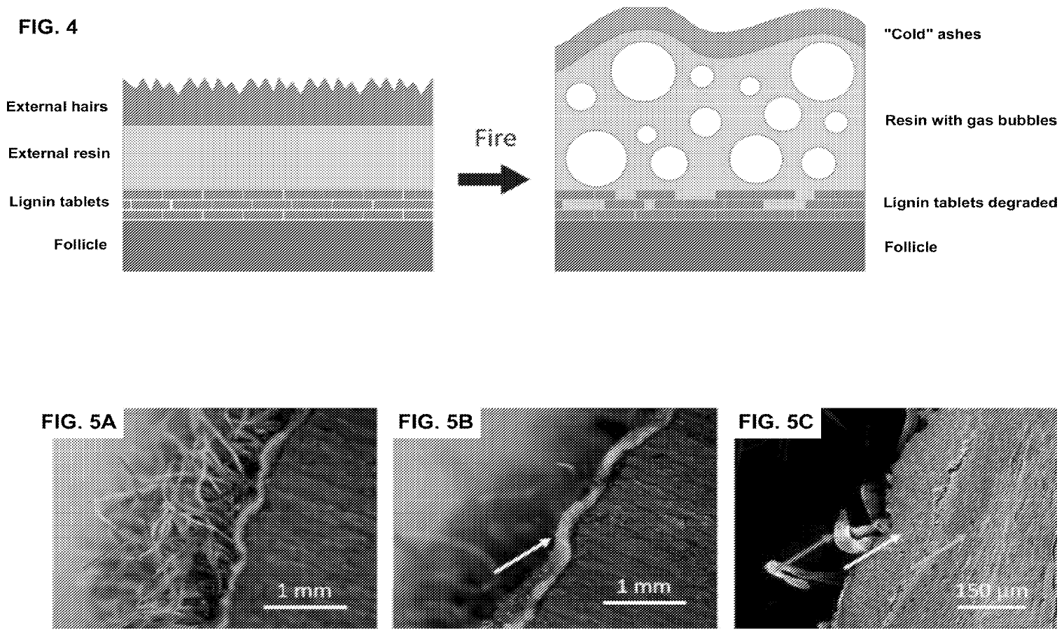

A typical wildfire thermal profile starts with a temperature ramp of 1-2 thousand degrees per second, up to 1000-1500° C. which is maintained for about 30 seconds, then the temperature decreases quickly to about 400-500° C. and is maintained for a few minutes. As protection from this first massive heat and the fire itself, which also include a massive damage due to oxidation, the system exposes a coverage made of hairs (mostly lignin and cellulose) and right underneath a resin layer (mostly crosslinked or/and high molecular weight apolar compounds). As shown in FIGS. 4 and 5A-5C, once exposed to high temperature, the hairs carbonize and the resin creates a foam with air pockets generating an insulating layer. It is possible that lignin is also dispersed inside the resin and its decomposition is responsible for the gas generated. A layer of lignin platelets is also observed right beneath the resin and may be responsible for the gas generated.

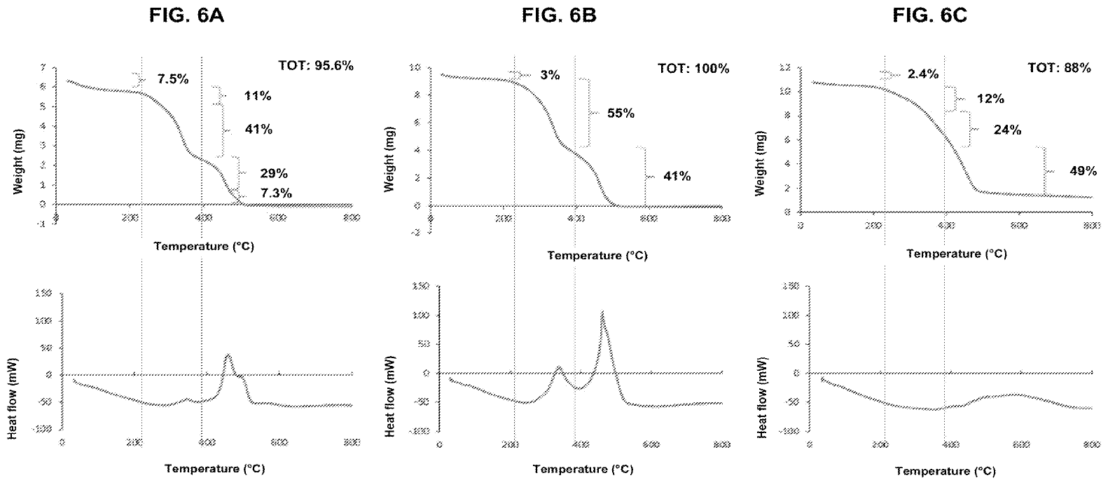

From TGA and DSC profile in air, it was observed how the external hairs initially lose over 50% of their weight (between 200-400° C.) with almost no thermal contribution as shown in FIG. 6A. In a natural environment, this would create a “cold” ashes layer giving few advantages: (i) generating an insulating carbonized layer; (ii) superficially consume the oxygen, creating an inert gas layer, and protect the resin from oxidative degradation; (iii) avoid the diffusion of fresh gas to the follicle surface and the resin. On the other hand, the TGA and DSC profile of the resin showed two different behaviors in air compared to an inert gas (Ar) as shown in FIG. 6B to FIG. 6C. In absence of oxygen, the degradation of the resin is slower (less steep and more homogeneous weight loss), and the thermal contribution related to degradation event is almost neutral instead of exothermic. These results suggest that the external hairs may act as a sacrificial layer that creates a microenvironment poor in oxygen for the resin to give the follicle thermal protection thanks to an intumescence effect.

### Example

The following is a non-limiting example of the present invention. It is to be understood that said example is not intended to limit the present invention in any way. Equivalents or substitutes are within the scope of the present invention.

In an exemplary embodiment, a protective coating can be applied to materials (e.g., using casting, 3D printing, spray coating, etc.) used in construction to protect from thermal exposure. This protective coating comprised of a sacrificial component embedded within an intumescent layer may absorb, scatter, and deflect heat to maintain protection as shown in FIG. 1B. Absorbing heat may occur via a phase transformation; scattering or deflection will redirect phonons around the components, thereby frustrating the transport and eventually dissipating heat.

In a vessel, an intumescent material is added with a sacrificial component and blended for a period of time. For example, a dilute suspension (e.g., 10 vol %, but can be more concentrated) of calcium oxalate particles (sacrificial material) is made in a solution of intumescent material (e.g., thermoplastic polymer-synthetic or biological). This suspension can then be applied to a surface (e.g., existing building material) using spray coating. The duration of the spraying, as well as the concentration of the suspension/viscosity of suspension will dictate the thickness. Upon drying, sacrificial particles will be embedded in the intumescent matrix.

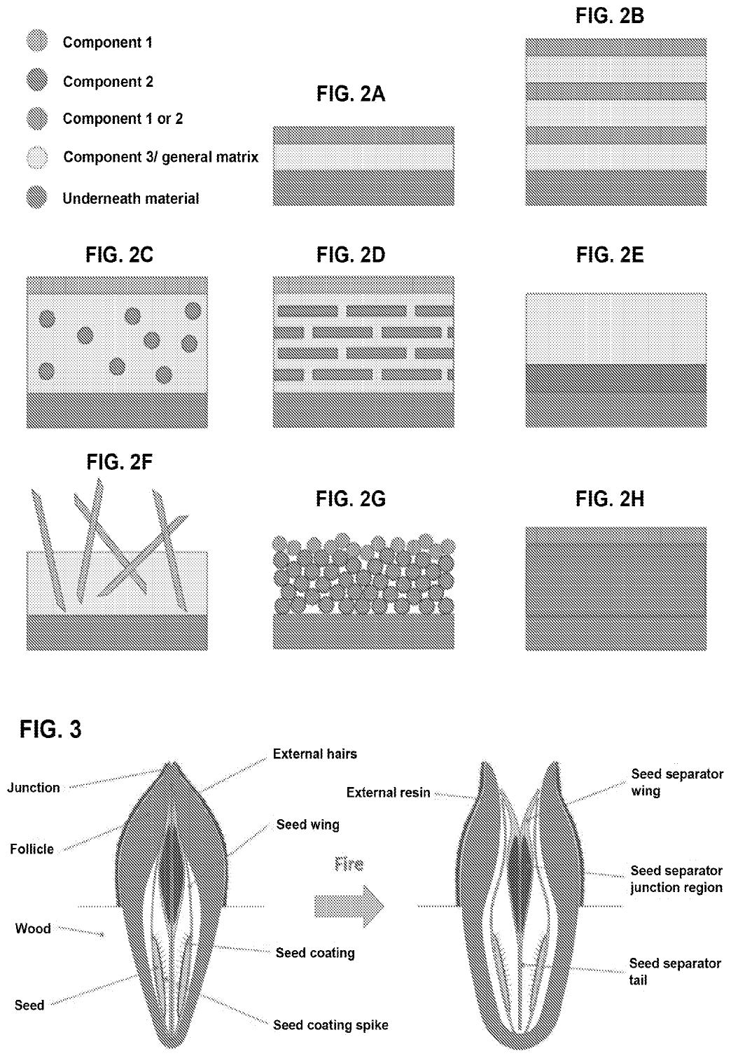

According to some embodiments, the present invention features a protective coating comprising at least one sacrificial layer and at least one intumescent layer as shown in FIG. 2A. In some aspects, the protective coating comprises a plurality of alternating intumescent and sacrificial layers. In some embodiments, the sacrificial layers are disposed on the intumescent layer as shown in FIG. 2B.

According to other embodiments, the present invention also features a protective coating comprising an intumescent layer as shown in FIG. 1C. In some embodiments, the present invention also features a protective coating comprising at least one intumescent layer and at least one sacrificial component as shown in FIG. 2E. In other embodiments, the sacrificial component is embedded in the intumescent layer. In some embodiments, the protective coating comprises a plurality of sacrificial fiber components embedded in the intumescent layers as shown in FIG. 2F.

According to some other embodiments, the present invention also features a protective coating comprising a sacrificial layer, and a sacrificial component embedded within an intumescent layer as shown in FIG. 2C. Alternative, the protective coating may comprise a sacrificial layer, and a sacrificial component stacked and embedded within an intumescent layer as shown in FIG. 2D.

According to other embodiments, the present invention also features a protective coating comprising at least one sacrificial component and at least one sacrificial layer as shown in FIG. 2H. According to other embodiments, the present invention also features a protective coating comprising a sacrificial component. This protective coating can have a particle-based morphology as shown in FIG. 2G.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1. A protective coating comprising at least one intumescent layer and at least one sacrificial component.

2. The coating of claim 1, wherein the sacrificial component is disposed on, layered under, or partially embedded or fully embedded in the intumescent layer.

3. (canceled)

4. The coating of claim 1, wherein the sacrificial component is comprised of particles, films, or stacks of tablets.

5. The coating of claim 1, wherein the sacrificial component is comprised of insulating materials that can undergo phase transformations.

6. (canceled)

7. The coating of claim 1, wherein the sacrificial component is adapted to thermally degrade and consume O₂ to form an ash layer that lowers a permeability of O₂ or prevents O₂ from passing through and acts as an insulating layer.

8. The coating of claim 1, wherein the sacrificial component is adapted to form a non-combustible gas when heated or burned.

9-10. (canceled)

11. The coating of claim 1, wherein the sacrificial component is adapted to form a gas, wherein said gas is noncombustible and fills spaces in the intumescent layer as the intumescent layer expands.

12. The coating of claim 1, wherein the sacrificial component degrades upon heating with a neutral or endothermic contribution.

13. A protective coating comprising at least one sacrificial layer and at least one intumescent layer.

14-15. (canceled)

16. The coating of claim 13, wherein the sacrificial layer is comprised of decomposable polymeric or inorganic materials.

17. The coating of claim 13, wherein the sacrificial layer is comprised of insulating materials that can undergo phase transformations.

18. (canceled)

19. The coating of claim 13, wherein the sacrificial layer is adapted to thermally degrade and consume O₂ to form an ash layer that lowers permeability of O₂ or prevents O₂ from passing through and act as an insulating layer.

20. The coating of claim 13, wherein the sacrificial layer is adapted to form a non-combustible gas when heated or burned.

21-22. (canceled)

23. The coating of claim 13, wherein the sacrificial layer degrades upon heating with a neutral or endothermic contribution.

24-34. (canceled)

35. A protective coating comprising at least one sacrificial component, at least one sacrificial layer, or a combination thereof.

36-37. (canceled)

38. The coating of claim 35, wherein the sacrificial component is comprised of particles, films, or stacks of tablets.

39. The coating of claim 35, wherein the sacrificial component and/or the sacrificial layer is comprised of thermally insulating materials that can undergo phase transformations.

40. (canceled)

41. The coating of claim 35, wherein the sacrificial component and/or the sacrificial layer is adapted to thermally degrade and consume O₂ to form an ash layer that lowers a permeability of O₂ or prevents O₂ from passing through, thereby providing thermal insulation.

42. The coating of claim 35, wherein the sacrificial component and/or the sacrificial layer is adapted to form a non-combustible gas when heated or burned.

43-44. (canceled)

45. The coating of claim 35, wherein the sacrificial component and/or the sacrificial layer degrades upon heating with a neutral or endothermic contribution.

46-66. (canceled)
